(19) United States
(12) Patent Application Publication
(10) Pub. No.: US 2009/0072534 A1
(43) Pub. Date: Mar. 19, 2009

(54) SEALED STRUCTURE OF CIRCULAR TUBULAR HEAT PIPE

(76) Inventor: Hul-Chun HSU, Taichung City (TW)

Correspondence Address: HDLS Patent & Trademark Services, P.O. BOX 220746, CHANTILLY, VA, 20153-0746, US

(21) Appl. No.: 12/274,485

(22) Filed: Nov. 20, 2008

Related U.S. Application Data
(63) Continuation-in-part of application No. 10/729,932, filed on Dec. 9, 2003.

(51) Int. Cl. F16L 13/00

(52) U.S. Cl. 285/286.2

(57) ABSTRACT

A sealed structure of a circular tubular heat pipe is formed on a distal opening of a heat pipe. A pressed recess portion recessed inwards from one side of a wall portion is formed on the distal opening. The wall portion of the distal opening is pressed from the pressed recess portion to the other side of the wall portion and is sealed therewith, thereby forming a flattened section of the heat pipe. The flattened section deflects toward one side of the body of the heat pipe, and it has two wing portions bending obliquely toward the pressed recess portion. The tip of one of the wing portions is brought into contact with the outside of the tip of the other wing portion, so that the flattened section forms a curled portion that reduces gradually from bottom to top.

This application is a continuation-in-part of U.S. patent application Ser. No. 10/729,932, filed Dec. 9, 2003.

### BACKGROUND OF THE INVENTION

1. Field of the Invention

The present invention relates to a heat pipe, and in particular to a sealed structure of a circular tubular heat pipe.

2. Description of Prior Art

As shown in FIG. 1, the sealed structure of a conventional heat pipe 1a is made by reducing a distal opening 10a of the heat pipe into a reduced portion 11a via a shrinking process, pinching the distal end of the reduced portion 11a to form a flattened section 12a via a sealing die (not shown), and welding the upper end of the flattened section 12a. In this way, the distal opening 10a of the heat pipe 1a can be sealed.

However, in the sealed structure of the conventional heat pipe 1a, the object of shrinking the distal opening 10a into a reduced portion 11a is to reduce the volume and cross-sectional area of the sealed portion of the distal opening 10a, thereby facilitating the subsequent welding process. Although the shrinking of the distal opening 10a can facilitate the welding process, the distal opening 10a after shrinking will make unstable the shape of the wick structure adhered to its inner wall. If the wick structure is filled within the heat pipe after the shrinking of the distal opening, it is more difficult to fill the wick structure due to the formation of reduced portion 11a, and the whole cost of the manufacturing process is increased.

For example, Japan Patent Publication No. 6-106269 discloses a sealed structure of a heat pipe and a method of the same. However, the cross section of the sealed structure formed in the above patent document is a “C” shape and is located in the center of the cross section of the heat pipe. Such a structure has lower strength and the wall portion of the heat pipe after pressing cannot be concentrated on one side of the cross section of the heat pipe. Thus, such a structure still occupies more space.

In view of the above, the inventor contemplates the foregoing drawbacks, employs related principles and thus provides a feasible design to efficiently improve the above drawbacks.

### SUMMARY OF THE INVENTION

The present invention is to provide a sealed structure of a circular tubular heat pipe, whereby the cross-sectional area of the sealed portion of the heat pipe can be reduced so as to facilitate the sealing process of the heat pipe.

The present invention provides a sealed structure of a circular tubular heat pipe, which is formed on a distal opening of a heat pipe. A pressed recess portion recessed inwards from one side of a wall portion is formed on the distal opening. The wall portion of the distal opening is pressed from the pressed recess portion to the other side of the wall portion, thereby forming a flattened section of the heat pipe. The flattened section deflects toward one side of the body of the heat pipe, and has two wing portions bending obliquely toward the inside of the pressed recess portion. The tip of one of the wing portions is brought into contact with the outside of the tip of the other wing portion, so that the flattened section forms a curled portion that reduces gradually from bottom to top. In this way, the sealed structure of the circular tubular heat pipe can be obtained.

### BRIEF DESCRIPTION OF DRAWING

FIG. 1 is a plan view showing the sealed structure of the conventional heat pipe;

FIG. 2 is a schematic view showing the external appearance of the present invention;

FIG. 3 is a schematic view showing the present invention being subjected to a pressing process;

FIG. 4 is a cross-sectional view of the present invention taken along the line 4-4 in FIG. 3;

FIG. 5 is a perspective view showing the external appearance of the present invention after being pressed;

FIG. 6 is top view of FIG. 5;

FIG. 7 is top view of FIG. 2; and

FIG. 8 is a schematic view showing the present invention in FIG. 2 being further welded.

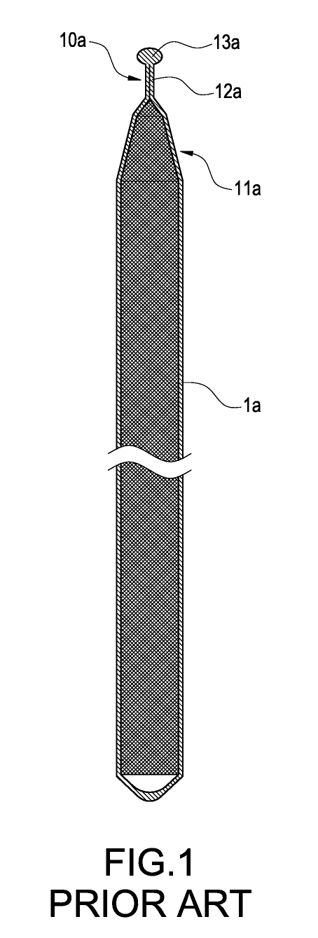

### DETAILED DESCRIPTION OF THE INVENTION

In order to make the Examiner further understand the characteristics and technical contents of the present invention, the present invention will be explained with reference to the accompanying drawings. However, it should be noted that the drawings are used to illustrate but not to limit the scope of the present invention.

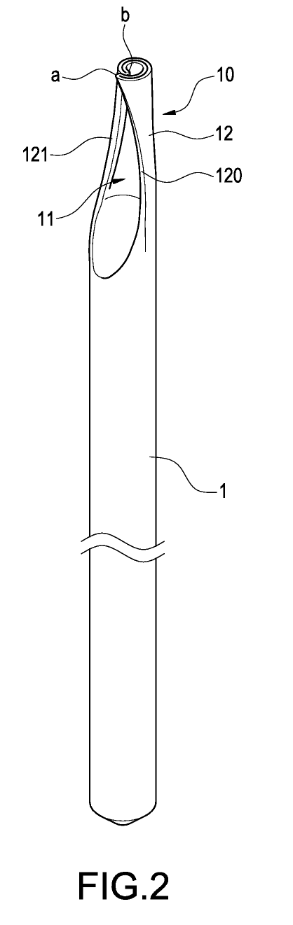

Please refer to FIG. 2, which is a schematic view showing the external appearance of the present invention. The present invention provides a sealed structure of a circular tubular heat pipe. The sealed structure is formed on a distal opening 10 of a heat pipe 1 for sealing the interior of the heat pipe 1. Via this arrangement, the working fluid sealed inside the heat pipe 1 can generate phase changes, thereby assuring the normal operation of the heat pipe 1.

In forming the sealing structure, the distal opening 10 of the heat pipe 1 is pressed, so that the wall portion of the distal opening 10 is pressed to be sealed. Then, the pressed wall portion of the distal opening 10 is further pinched to centralize and reduce its area. The process for manufacturing the sealed structure of a heat pipe is described as follows.

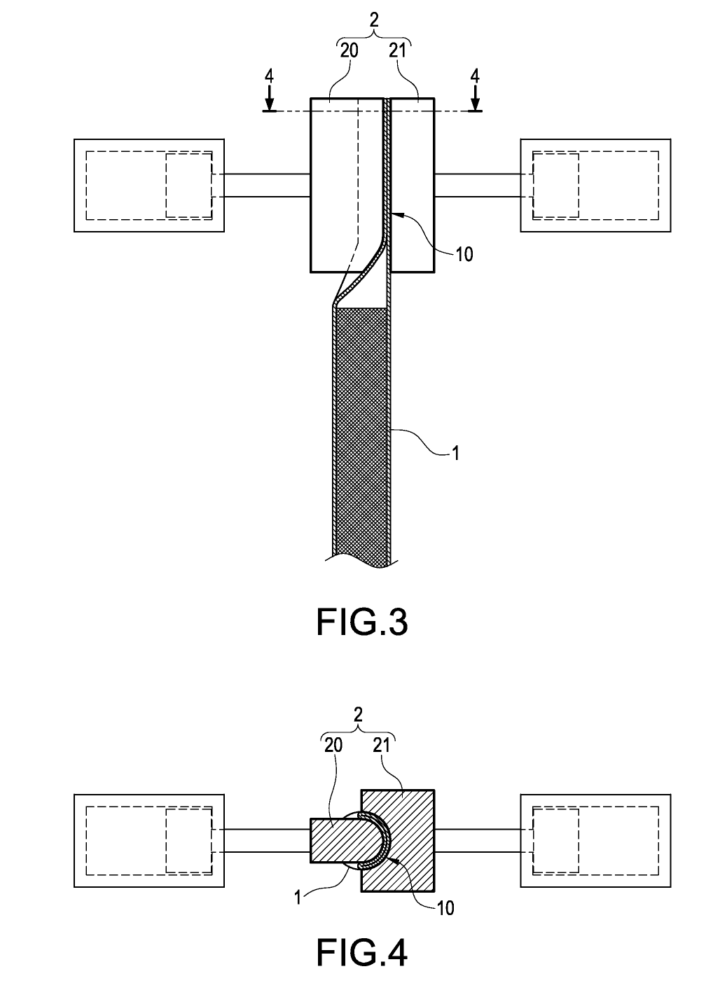

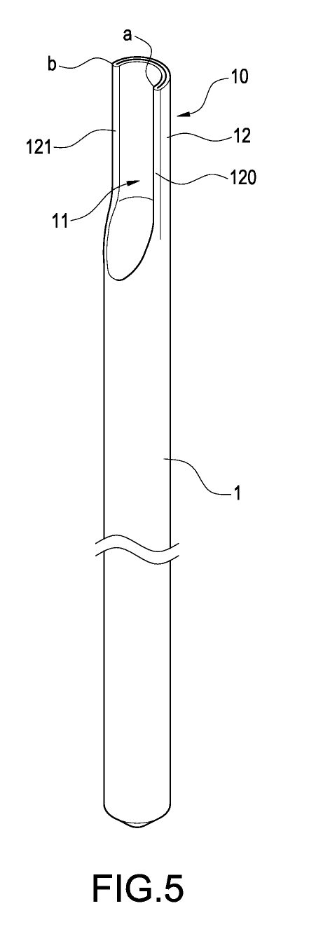

As shown in FIGS. 3 and 4, first, the distal opening 10 of the heat pipe 1 is disposed in a press die 2. The press die 2 includes a first mold 20 and a second mold 21. The first mold 20 and the second mold 21 are formed respectively into a convex mold and a concave mold that correspond to each other. The first mold 20 and the second mold 21 are used to press the distal opening 10 of the heat pipe 1, thereby forming the sealed structure shown in FIG. 5.

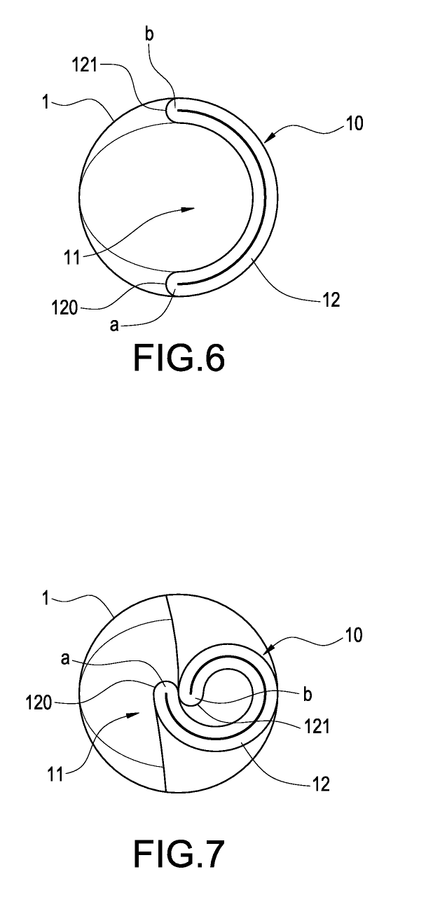

Please refer to FIG. 5 again. After the heat pipe 1 is pressed to be sealed completely, a pressed recess portion 11 recessed inwards from one side of the wall portion is formed on the distal opening 10 of the heat pipe 1. The wall portion on the distal opening 10 is pressed from the pressed recess portion 11 to the other side and is sealed therewith, thereby forming a flattened section 12 with a semi-circular arched cross section (FIG. 6). The flattened section 12 has two wing portions 120, 121. The two wing portions 120, 121 are formed by bending the wall portion of the distal opening 10. Then, the two wing portions 120, 121 of the flattened section 12 having a semi-circular arched cross section are bent obliquely toward the inside of the pressed recess portion 11 in such a manner that the tip a of one wing portion 120 is brought into contact with the outside of the tip b of another wing portion 121, so that the flattened section 12 forms a curled portion reducing gradually from bottom to top (FIG. 2). In this way, the flattened section 12 deflects toward one side of the body of the heat pipe 1 (FIG. 7), thereby forming the sealed structure of the circular tubular heat pipe of the present invention.

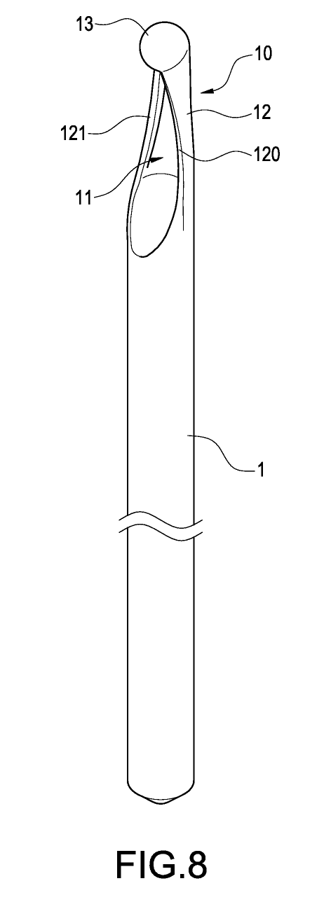

Furthermore, as shown in FIG. 8, after the sealed structure shown in FIG. 2 (or FIG. 8) is completed, the distal opening 10 of the heat pipe 1 (i.e. the top edge of the flattened section 12) is subjected to brazing, soldering, welding, or other sealing process, thereby forming a spherical sealed head 13 on the distal opening 10. In this way, the tightness of sealed structure of the heat pipe 1 can be improved.

Therefore, via the sealed structure of the circular tubular heat pipe of the present invention, since the flattened section 12 deflects toward one side of the body of the heat pipe 1, and the two wing portions 120, 121 are curled together, the cross-section area thereof can be reduced efficiently, thereby facilitating the sealing process of the heat pipe 1. In addition, the flattened section 12 that reduces gradually form bottom to top provides a larger strength, thereby facilitating the subsequent sealing process.

According to the above, the present invention can solve the drawbacks of prior art and achieve the expected purposes. Further, it indeed involves novelty and inventive steps and thus conforms to the requirements for an invention patent.

Although the present invention has been described with reference to the foregoing preferred embodiment, it will be understood that the invention is not limited to the details thereof. Various equivalent variations and modifications can still be made in view of the teachings in the claims and specification of the present invention. Thus, all such variations and modifications are also embraced within the scope of the invention as defined in the appended claims.

What is claimed is:

1. A sealed structure of a circular tubular heat pipe, formed on a distal opening of a heat pipe, wherein a pressed recess portion recessed inwards from one side of a wall portion is formed on the distal opening, the wall portion of the distal opening is pressed from the pressed recess portion to the other side of the wall portion and is sealed therewith, thereby forming a flattened section of the heat pipe; the flattened section deflects toward one side of the body of the heat pipe, and it has two wing portions bending obliquely toward the inside of the pressed recess portion; the tip of one of the wing portions is brought into contact with the outside of the tip of the other wing portion, so that the flattened section forms a curled portion that reduces gradually from bottom to top.

2. The sealed structure of a circular tubular heat pipe according to claim 1, wherein the top edge of the flattened section is provided with a sealed head.

3. The sealed structure of a circular tubular heat pipe according to claim 2, wherein the sealed head is formed by welding.

4. The sealed structure of a circular tubular heat pipe according to claim 2, wherein the sealed head is formed by a fusing process.

5. The sealed structure of a circular tubular heat pipe according to claim 4, wherein the fusing process is brazing.

6. The sealed structure of a circular tubular heat pipe according to claim 4, wherein the fusing process is soldering.
